(19) United States
(12) Patent Application Publication
(10) Pub. No.: US 2003/0112970 A1
(43) Pub. Date: Jun. 19, 2003

(54) How to generate unbreakable key through any communication channel

(76) Inventor: Arindam Mitra, Calcutta (IN)

Correspondence Address: ARINDAM MITRA, PO. LAKURDHI, TIKARHAT ROAD, BURDWAN, W.B, 713102, IN

(21) Appl. No.: 10/222,323

(22) Filed: Aug. 15, 2002

Related U.S. Application Data
(60) Provisional application No. 60/315,201, filed on Aug. 26, 2001.

(51) Int. Cl. H04L 9/00

(52) U.S. Cl. 380/44

(57) ABSTRACT

The long-standing problem of secure communication is to distribute/generate unbreakable key over a communication channel. Classically the problem is believed to be unsolvable. For secure communication and authentication we are dependent on computationally secure cipher systems. Over the last two decades quantum key distribution systems have been developed to solve the problem, but the problem is yet to be solved in practical settings. The invented classical key distribution/generation system solves the problem.

### FIELD OF THE INVENTION

This invention relates to a method of generating unbreakable identical keys at two or more distant stations. The generated keys can be used both for secret message encryption and authentication.

### BACKGROUND OF THE INVENTION

In classical cryptography, Vernam cipher popularly known as one-time-pad, is the most important cipher system because it is proven absolutely secure. But the drawback of this system is that it cannot re-use key. Key materials need to transported securely by one user to other whenever their stock of keys gets exhausted. Due to this difficulty, it never became popular. At present, data encryption standard (DES) and public key distribution (PKD) are widely used cipher systems because they provide computationally security. As the issue is security, these two systems often face criticism because their computational security is not proven. Moreover, the rapid progress of computational power is a threat to its security particularly when some of them have already been cracked by massive computation.

So the major problem of cryptography is to generate key at two distant places over communication channel in such a way the generated key will remain unbreakable. As over the decades there is no major break through in this field it seemed that classically the problem is insurmountable. In this background we have no other way but to rely on computational security albeit its weak foundation. A radical idea was put forwarded by S. Wiesner pointing out that security of private data can be ensured by the laws of quantum mechanics if quantum state is used to encrypt private data. Subsequently Bennett and Brassard discovered a quantum key distribution (QKD) system. Since then, interest on quantum cryptography has been rapidly growing. Many experiments have already been performed.

In QKD system eavesdropping will be detected because eavesdropper will certainly disturb quantum state used for the encryption. As a result data will be corrupted. This is true when there is no noise. But noise is always present and noise itself corrupts some data. Eavesdropper can use noise as a shield. Ultimately noise poses a serious threat to the security of QKD. In the last few years, work on its security has been remarkably progressed. But a simple proof of security for practical setting is yet to be found. Henceforth by security we shall mean absolute security.

Apart from the security problem existing quantum cryptography has the following conceptual drawbacks: 1. it needs classical authenticated channel to establish the security of quantum channel. 2. it cannot ensure security of an individual created bit. 3. Like classical cipher system message cannot be directly transmitted securely without encrypting in a key.

To remove the above conceptual problems alternative quantum encryption has been proposed by the present inventor (references 2,3). Needless to say, it is free from the above conceptual difficulties. The alternative encryption is based on the method of reusing secret information again and again. Like other QKD systems alternative QKD system provides security if there is no noise. But after some crypto-analysis I have come to the conclusion that noise is fatal for alternative QKD system.

The present status of two types of quantum cryptographic system can be summarized in the following way:

Security of existing conventional QKD against eavesdropping remains unproved in practical settings but it is proved that it cannot provide security against cheating in case of quantum bit commitment (QBC) and quantum coin tossing (QCT)—bit commitment and coin tossing are two important cryptographic primitives which deal with cheating of one user by other. Bennett and Divincenzo briefly the present status of existing conventional quantum cryptography in a paper published in Nature, 404, 247, 2000.

On the other hand it remains to be proved that in presence of noise alternative quantum cryptography cannot provide security against eavesdropping, however it has been proved (reference 3) that it provides security against cheating in case of QBC and QCT. The present status of research on quantum cryptography demands that we need a radically new key distribution system which will fulfill the goal of quantum key distribution. And it will be advantageous if we can incorporate alternative QBC and QCT into that new key distribution system since we will get a key secured against eavesdropping and cheating.

We have invented such key distribution system. Although the invention was first flashed by the present inventor on http://xxx.lanl.gov/physics/0008042, but its implications were not then fully realized. The invented system is a classical key distribution system in the sense that its security is based on the classical law of probability. We have observed that it can incorporate alternative QBC and QCT. Therefore security against eavesdropping and cheating is simultaneously achievable.

### SUMMARY OF THE INVERNTION

Sender, henceforth be called Alice, and receiver, henceforth be called Bob, have a shared secret key K(2n) where K(2n) is a sequence of 2n random number R and P. It means they share two sub keys K^{r}(n) and K^{p}(n) which are basically two position-keys because K^{r}(n) contains the positions of R in the key

K(2n) and K^{p}(n) contains the positions of P in the key K(2n). The positions of random number R and P are denoted by r and p. Obviously R and P can represent binary 0 and 1 respectively or vice versa.

Alice encrypts a pair of keys k₁^{r}(n) and k₁^{p}(n) in the two sub keys K^{r}(n) and K^{p}(n) and prepare an double encrypted key K₁^{e}. It means position of each bit values of the two keys have been changed. In the encrypted double key K₁^{e}, bit values of k₁^{r}(n) take the r positions and k₁^{p}(n) take the p positions of the shared key. Now the encrypted double key is transmitted. In the same way in each time, denoted by i, Alice encrypts a pair of key k₁^{r}(n) and k₁^{p}(n) in the same sub keys K^{r}(n) and K^{p}(n) respectively and transmits each encrypted double key K₁(2n) to Bob. Thus she can encrypts total 2ⁿ⁻¹ pairs of keys. Applying the same sub keys K^{r}(n) and K^{p}(n) on each double encrypted key K₁^{e}, Bob decrypts each pair of keys kᵢ^{r}(n) and kᵢ^{p}(n). Each generated key can be separately used to encode secret message.

In cryptographic system, be it classical or quantum, encryption is done by Alice and decryption is done by Bob. In the above description this standard procedure has been followed. In another embodiment of the above system Alice does not have to encrypt keys. Both Alice and Bob will decrypt keys from the sequence of random numbers transmitted by third party, henceforth be called Eve. Still they will get identical keys without further any communication. This embodiment is described below.

Alice and Bob will share key K(2n) and its sub keys K^{r}n) and K^{p}(n) as like before. Each time Eve will transmit the same sequence of 2n random bits both to Alice and Bob. Alice and Bob will consider the sequence as double encrypted key K₁^{e}(2n) wherein encryption is assumed to be executed by the random number generator of Eve. Both Alice and Bob will decrypt two keys kᵢ^{r}(n) and k₁^{p}(n) from each double encrypted double key using the same sub keys K^{r}n) and K^{p}(n). Eve can transmits total 2²ⁿ different sequences of 2n random bits. Using the same sub keys K^{r}(n) and K^{p}(n) Alice and Bob will decrypt total 2²ⁿ⁺¹ keys of n random bits from total 2²ⁿ random sequences of 2n bits. The maximum number of completely different keys of n bits is 2ⁿ which, according to the first embodiment, can be generated by 2ⁿ⁻¹ sequences each containing 2n random bits. Therefore, among the decrypted keys all are not different keys. After checking the decrypted keys only completely different keys are retained. The rests are discarded.

The positions r and p have been re-used, but the numbers have never been re-used. That is why the question of degradation of security will not arise. Eavesdropper has to guess the generated keys because he has to guess the shared key and its sub keys.

### BRIEF DESCRIPTION OF THE DRAWINGS

FIG. 1 shows two position keys of a 8-bit shared key are used to generate two 4-bit keys.

FIG. 2 shows one embodiment of the system wherein Alice encrypts a pair of keys in the two sub keys and Bob decrypts the pair of keys using the same two sub keys.

FIG. 3 shows another embodiment of the system wherein Alice and Bob each time extract the same pair of keys from the two identical sequences of random bits transmitted by Eve.

### DETALED DESCRIPTION OF THE INVENTION

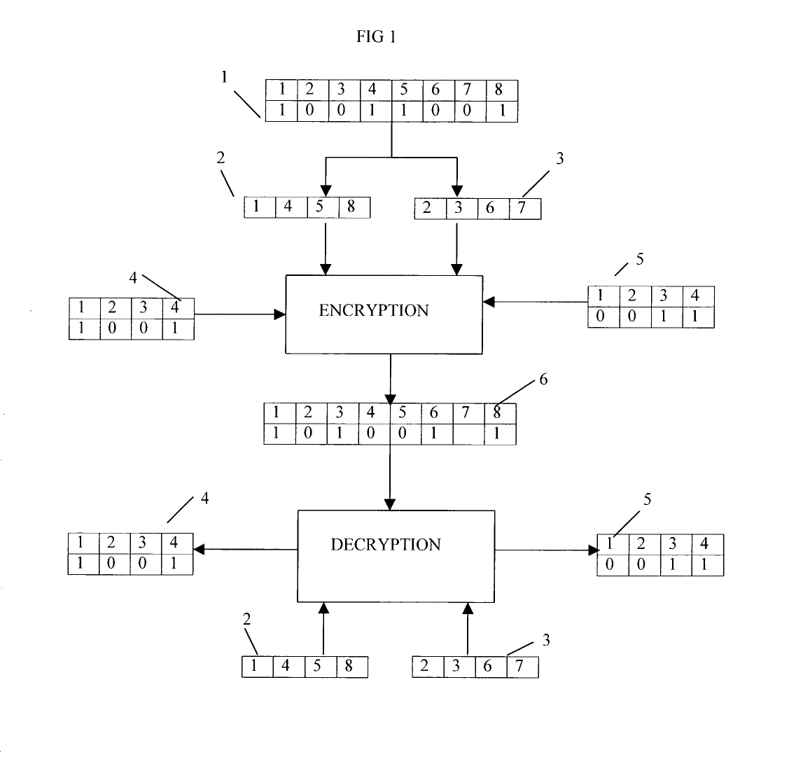

In FIG. 1 encryption-decryption has been described in block diagram form. In the FIG. 1 two shared secret sub keys 2 and 3 of 8-bit shared secret key 1 are used to encrypt and decrypt two 4-bit keys 4 and 5. Here sub key 2 encrypts and decrypts the key 4 and sub key 3 encrypts and decrypts the key 5.

Re-use of the sub keys is further illustrated below.

Suppose shared secret key is

K(2n)={P, R, R, R, P, R, P, R, P, P, P, R, P, R, R, P, . . . }.

The two position-keys are

K^{r}(n)={2, 3, 4, 6, 8, 12, 14, 15, . . . }

K^{p}(n)={1, 5, 7, 9, 10, 11, 13, 16, . . . }

The encrypted double keys will look like:

P R R R P R P R P P P R P R R P . . . = K(2n)
0 1 0 1 1 1 0 1 0 1 0 0 1 0 0 1 . . . = K₁^{e} (2n)
1 1 0 0 1 1 1 0 1 0 0 0 0 1 1 0 . . . = K₂^{e} (2n)
1 0 1 0 0 1 0 1 0 1 1 0 1 0 1 0 . . . = K₃^{e} (2n)
1 1 0 0 1 1 0 1 1 0 1 0 0 1 0 0 . . . = K₄^{e} (2n)
. . .
. . .
. . .
0 1 1 1 0 0 1 0 1 0 0 1 1 0 0 1 . . . = Kₘ^{e} (2n)

In the above block, the first row is a sequence of random numbers R and P. This sequence is shared secret key. The next rows represent the encrypted double key: K₁^{e}, K₂^{e}, K₃^{e}, K₄^{e}, . . . Kₘ^{e}, where m=2ⁿ⁻¹.

From each encrypted double key Kᵢ(2n) each k₁^{r}(n) and k₁^{p}(n) are decrypted.

The decrypted keys k₁^{r}(n) are

| R₂ | R₃ | R₄ | R₆ | R₈ | R₁₂ | R₁₄ | R₁₅ | . . . = K^{R}(n) |
|---|---|---|---|---|---|---|---|---|
| 1 | 0 | 1 | 1 | 1 | 0 | 0 | 0 | . . . =k₁^{r}(n) |
| 1 | 0 | 0 | 1 | 0 | 0 | 1 | 1 | . . . =k₂^{r}(n) |
| 0 | 1 | 0 | 1 | 1 | 0 | 0 | 1 | . . . =k₃^{r}(n) |
| 1 | 0 | 0 | 1 | 1 | 0 | 1 | 0 | . . . =k₄^{r}(n) |
| . . . | | | | | | | | |
| . . . | | | | | | | | |
| . . . | | | | | | | | |
| 1 | 1 | 1 | 0 | 0 | 1 | 0 | 0 | . . . = kₘ^{r}(n) |

The decrypted keys k₁^{p}(n) are

| P₁ | P₅ | P₇ | P₉ | P₁₀ | P₁₁ | P₁₃ | P₁₆ | . . . = K^{p}(n) |
|---|---|---|---|---|---|---|---|---|
| 0 | 1 | 0 | 0 | 1 | 0 | 1 | 1 | . . . = k₁^{p}(n) |
| 1 | 1 | 1 | 1 | 0 | 0 | 0 | 0 | . . . = k₂^{p}(n) |
| 1 | 0 | 0 | 0 | 1 | 1 | 1 | 0 | . . . = k₃^{p}(n) |
| 1 | 1 | 0 | 1 | 0 | 1 | 0 | 0 | . . . = k₄^{p}(n) |
| . . . | | | | | | | | |
| . . . | | | | | | | | |
| . . . | | | | | | | | |
| 0 | 0 | 1 | 1 | 0 | 0 | 1 | 1 | . . . = kₘ^{p}(n) |

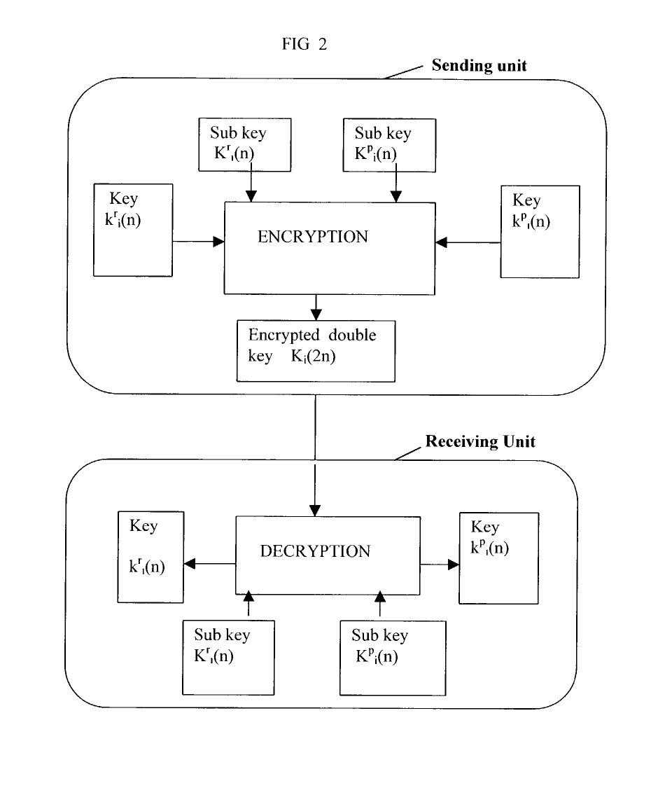

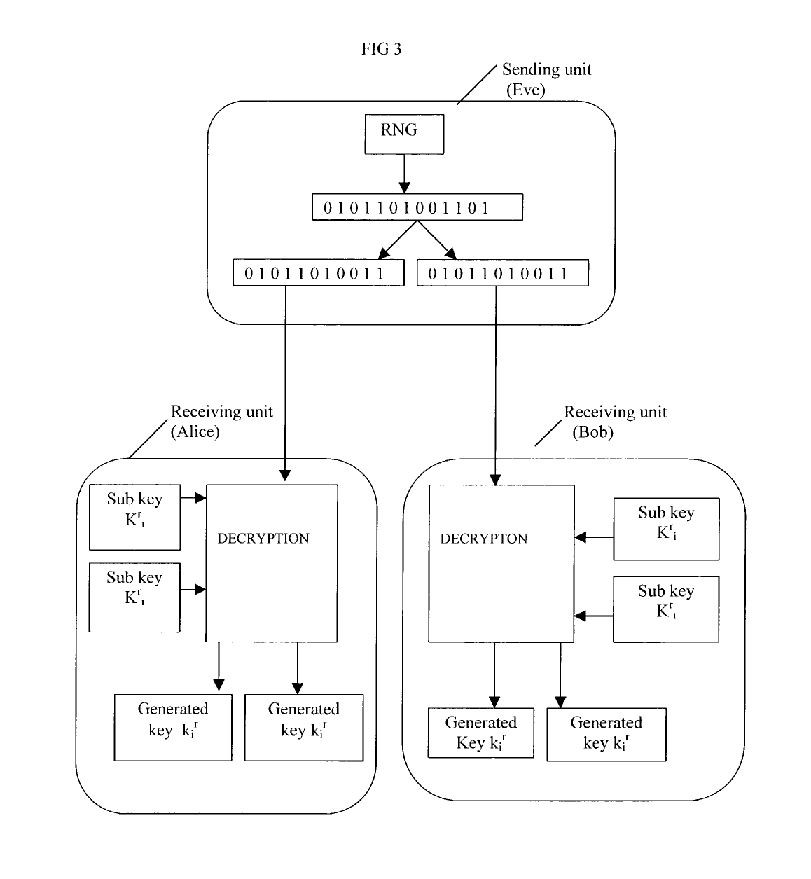

According to FIG. 2 Alice encrypts each pair of keys and transmits each encrypted double key to Bob via the communication channel. Bob decrypts each pair of encrypted key from the encrypted double key. So sender and receiver are engaged in the encryption and decryption. According to FIG. 3 Eve's random number generator encrypts each pair of keys although Eve's random number generator or Eve do know their shared secret key and sub keys. Eve transmits each encrypted double key both to Alice and Bob. Alice and Bob decrypt each pair of keys from the received encrypted double key using the shared secret two sub keys. Here we have described a sequence of random number as an encrypted double key because Alice and Bob get identical pair of keys without encrypting any thing.

The power of cryptographic system is determined by how much security it provides. In cryptography, a key is called absolutely secure if eavesdropper has to guess the key from all possible keys. Let us examine this notion of absolute security. Consider two one-time-pads T₁ and T₂. The T₁ and T₂ consist of 56 and 28 bits respectively. Both are absolutely secure systems. For these two systems, code breaker's probabilities of correct guessing are: p_{g}(T₁)=½⁵⁶ p_{g}(T₂)=½²⁸. The T₁ is not more absolutely secure than T₂. Both are considered absolutely secure without considering eavesdropper's probability of correct guessing. So we define two types of absolute security—conservative absolute security and logical absolute security (CAS and LAS). If eavesdropper has to guess from all possible keys then system will provide CAS, but if he has to guess from the lesser number of keys than all possible keys it will provide LAS. For the presented scheme we can achieve CAS or LAS whatever we wish.

In the invented system eavesdropper will never get the keys with certainty. He will have to depend on guessing. He can pursue either systematic or random strategy of guessing (SG or RG). In systematic guessing, he will try to guess each pair of key from the same guessing of the two shared secret position keys and in random guessing, he will try to guess each pair of keys by each time new guessing of the two shared secret position keys.

If users use each generated key to encode secret message then system will give CAS. Suppose code breaker is trying to guess a key kᵢ^{r}(n) or k₁^{p}(n). Essentially he has to guess that key from 2ⁿ possible keys. The probability of correct guessing (p_{g}) is ½ⁿ. Now for the next keys following SG or RG, he can try to guess. Both for these two strategies, p_{g} is ½ⁿ for each keys.

If Alice and Bob want to use many pairs of generated keys as a single key to encode secret message then system will give LAS.

Suppose they want to make a single final key K^{F} from the total number of generated keys. The generated keys can be arranged in many ways. Let us take the following regular arrangements of two kind of keys k₁^{r}(n) and kᵢ^{r}(n) occupying even and odd positions in the final key respectively. That is, K_{F}={k₁^{r}, k₁^{p} k₂^{r}, k₂^{p}, k₃^{r}, k₃^{p}, k₄^{r}, k₄^{r} . . . }. In favor of eavesdropper let us assume that this arrangement is not a secret. Still he has to guess the final key, but now he has in advantageous position. His SG will give him better result than his HG. First, code breaker guesses the first key K₁^{r}. His chances of correct guessing is ½ⁿ. Next following SG, he guesses all the subsequent keys. This is the best strategy code breaker can think of. If he pursues RG, then the probability of correct guessing the final key is ½^{n.2}^{ⁿ}. The total number of bits in the final key is 2^{n.2}^{ⁿ}. The probability of correct guessing the final key from all possible keys is ½^{2.2}^{ⁿ} which is equal to the probability of correct guessing for RG. By SG he can reduce p_{g} to ½ⁿ. This is the price we have to pay for the repetitive use of the shared key. So the final key provides LAS.

In FIG. 1. encryption has been done with new new pairs of keys by Alice. Before encrypting the each pair Alice checks whether the keys are new (not identical to previously transmitted keys). If each pair of keys is decrypted both by Alice and Bob from each sequence of random bits, transmitted by Eve, as described by FIG. 2, then after decryption Alice and Bob checks whether the decrypted keys are new. They retain only different keys. However the probability of repetitions of a key for both usage is ½ⁿ. Therefore this check is not very stringent for moderately large n as for example n=28. 56 bit key and its two sub key give approximately 10¹⁰ bits. However generated bits can be used as shared bits. Then system will run on generated bits. In this way infinite number of absolutely secure bits can be produced.

In presence of noise, transmitted keys will be corrupted. Noise can affect the perfect transmission of the keys not its security. Noise is a threat to security of quantum keys. It is not threat to the security of classical cipher system. Even a powerful computationally secure classical cipher system can be based on noise (ref 5). Perfect transmission of the keys in presence of noise is simply possible if bits are sent as messages through public communication channel, say, via telephone line or radio link.

It is well known that problems of key distribution and a authentication are identical. One-time-pad and Wegman Carter authentication are absolutely secure. But both cannot re-use key. As the present invention overcomes the problem of one-time-pad, it also overcomes the problem of Wegman and Carter in two different ways.

For authentication purpose the system can be used in two ways. In one embodiment as depicted in FIG. 2 Alice encrypts the pair of keys where it was assumed that none of the bits of the two keys-to-be-transmitted are shared secret bits. Authentication needs some shared secret bits. In the invented system shared secret bit are not used only shared secret positions are used but the positions can be reused. So the problem of authentication can be over in the following way. First time encryption Alice will not encrypt totally unknown pair of keys rather she will encrypt two keys where some portion of at least one of the key is known to Bob. Therefore other initially unknown bits are authenticated. The authenticated generated bits can be used for further authentication. In this technique each generated bits are simultaneously absolutely secure against eavesdropping and impersonating attacks.

In the second method of authentication Alice encrypts pair of keys which are totally unknown to Bob. Bob decrypts the pair from the encrypted key. With the generated bits and some shared secret bits authentication can be done. After authentication the rest of the generated authenticated bits can be used for further authentication.

In other embodiment as depicted in FIG. 2 this second method has to be followed for authentication since here Alice is not encrypting keys.

The system opens up a new possibility of decrypting keys from a single sequence of random bits by many pairs (or more than two) of separate users where each pair of users will get their own pair of keys. As if many couples are eating the same pie but none of the couple is sure what other couples are eating. The system will be economical.

Another advantage is that Alice has no need of keeping random number generator (RNG) to prepare encrypted double key. According to FIG. 3 Alice and Bob do not need any RNG. But in the embodiment depicted in FIG. 2 it not clear whether Alice needs a RNG. According to FIG. 3 Alice and Bob decrypts keys. Now Suppose Bob is not connected to Eve. So only Alice is connected to Eve. Therefore, Alice will decrypt keys. The decrypted keys can be further encrypted and then transmitted to Bob. So even for the embodiment of FIG. 2 Alice does not need any random number generator. It means there is no need to trust any third party. To have secret key they need one time a random number generator or they can collect the shared secret key from other's random number generator if they can collect it secretly.

Although the invention has been called as classical key distribution/generation system but it will be apparent that electromagnetic signal or a quantum state or a sequence of quantum state can represent a random number R or P.

In the description Bob gets each complete key when Alice sends keys, it will be also apparent to those skilled in the art that each key can also be split among more than one legitimate receivers so that all are forced to cooperate with each other to construct the transmitted key.

It will be further apparent that system can incorporate alternative encryption because in alternative encryption a sequence of quantum states or two entangled sequences represent(s) a bit value. In alternative QBC and QCT encoding cheating-free bit can be generated by splitting one bit of information in more than one steps. Therefore those skilled in this art can hope to generate key secure against eavesdropping as well as cheating by implementing alternative QBC or QCT on the top of the invented system. This incorporation is important because I do believe neither classical nor quantum system could accomplish the dual task. Indeed this is possible that I shall describe elsewhere.

Reference cited
Patent Documents

| | | |
|---|---|---|
| 5307410 | Apr., 1994 | Bennett |
| 5515438 | May., 1996 | Bennett et al |
| 5675648 | Jan., 1998 | Townsend |
| 5757912 | May., 1998 | Blow |
| 5764765 | May., 1998 | Phoenix et al |
| 5953421 | Sep., 1999 | Townsend |

Other References

1. A. Mitra, “An alternative information processing technique.” (To be submitted in Physical Review Letters)

2. A. Mitra, “Entanglement can be used to transmit message.” Mitra. A (To be submitted in Physical Review Letters)

3. A. Mitra, “Entanglement can disallow dishonesty in bit commitment.” (To be submitted in Physical Review Letters)

4. A. Mitra, “A simple unbreakable cipher system”, at http://xxx.lanl.gov/physics/0008042

5. A. Mitra, “Noise-based cipher system”, at http://xxx.lanl.gov/quant-ph/9912074

pair of keys

I claim:

1. A Communication system comprising:
at least one sending unit and at least one receiving unit connected to a communication channel,
sharing a secret key for the purpose of generating new keys over the said communication channel by re-using the sub keys,
where key is a sequence of random numbers and sub key is a sequence of random positions of random number.

2. The system described in claim 1 wherein the said secret key, denoted by K(2n) , is a sequence of 2n random numbers, denoted by P and R, and two of its sub keys, denoted by K^{r}(n) and K^{p}(n), are the two sequences of random positions of random numbers R and P respectively, where r and p denote the position of R and P in the key K(2n).

3. The system described in claim 2 includes the steps of:
the said sending unit encrypting a pair of keys, denoted by k₁^{r}(n) and k₁^{p}(n), in the said two sub keys K^{r}(n) and K^{p}(n) respectively;
and thereby constructing a encrypted double key, denoted by K₁^{e}(2n),
where encryption means in the encrypted double key K₁^{e}(2n) , the successive bit values of k₁^{r}(n) and k₁^{p}(n) are encrypted in the positions of R and P respectively;
then the said sending unit transmitting the encrypted sequence K₁^{e}(2n) through the said communication channel to the said receiving unit;
the said sending unit taking another new pair of keys, k₂^{r}(n) and k₂^{p}(n), encrypting in the same two sub keys K^{r}(n) and K^{p}(n), and constructing another new encrypted double key, K₂^{e}(2n);
and thereafter transmitting to the said receiving unit through the said communication channel;
and following this technique, the said sending unit encrypting always new pair of keys, kᵢ^{r}(n) and kᵢ^{p}(n) in the same two sub keys, Kᵣ(n) and K^{p}(n), and thereby creating always a new encrypted double key Kᵢ^{e}(2n) and transmitting the encrypted double key to the said receiving unit over the said communication channel;
where the system is capable of encrypting total 2ⁿ⁻¹ pairs of keys and total 2ⁿ different keys in the same sub keys, K^{r}(n) and K^{p}(n); and
the said receiving unit decrypting each pair of keys kᵢ^{r}(n) and kᵢ^{p}(n) after receiving each encrypted double key K₁^{e}(2n) using the said two sub keys K^{r}(n) and K^{p}(n).

4. The communication system of claim 3 further includes the following steps of authentication:
the said sending unit encrypting the first pair of keys k₁^{r}(n) and k₁^{p}(n) in the said two sub keys K^{r}(n) and K^{p}(n), where some of the bits of at least one of the two encrypted keys is secretly shared between the said sending unit and the said receiving unit, and
the said receiving unit recovering the shared secret bits decrypting the pair of keys by using the sub keys K^{r}(n) and K^{p}(n), and thereby authenticating the said sending unit and as well as authenticating the remaining generated bits which can be used for next time authentication.

5. The communication system of claim 3 further considers alternative authentication wherein the shared secret bits and some bits of the generated bits, which are not shared secret bits, are used to authenticate the remaining generated bits;
and the authenticated generated bits are used in next time authentication.

6. The communication system according to claim 2 further considers perfect transmission of each bit as a message by further encoding, and
imperfect transmission of each signal representing a bit when error is acceptable within the tolerable limit.

7. The communication system comprising:
at least two receiving units, each connected to one sending unit by communication channel where the said two receiving units sharing a secret key for the purpose of generating new keys over the two said communication channels by re-using the sub keys,
where key is a sequence of random numbers and sub key is a sequence of random positions of random number, and
the said sending unit is not aware of the said secret key and its sub keys.

8. The system described in claim 7 wherein the said secret key K(2n) is a sequence of 2n random numbers, denoted by P and R, and two of its sub keys, denoted by K^{r}(n) and K^{p}(n), are the two sequences of random positions of random numbers R and P respectively, where r and p denote the position of R and P in the key K(2n).

9. The communication system of claim 8 further includes the steps of:
the said sending unit generating a sequence of 2n random bits both to the two receiving units and another copy of that sequence to other receiving through two separate communication channels;
the said sending unit generating different sequences of 2n random bits and transmitting each sequence both to the said two receiving units through communication channels;
where each transmitted sequence, denoted by Sᵢ(2n), is considered by the said two receiving units as an encrypted double key Kᵢ(2n) of the two keys kᵢ^{r}(n) and k₁^{p}(n); and
considering this, the said two receiving units decrypting each pair of keys k₁^{r}(n) and k₁^{p}(n) from each received sequence Sᵢ(2n) operating the same two sub keys K^{r}(n) and K^{p}(n) on each received sequence Sᵢ(2n).

10. The communication system in claim 8 wherein all the decrypted keys will not be different keys because each time a pair of short keys is decrypted from a longer key and therefore the said two receiving units will keep only the different keys rejecting other keys.

11. The communication system in claim 8 wherein the said two receiving units are connected by a communication channel to utilize the decrypted keys in secret message transmission and for authentication;
and thereby one of the receiving unit becomes sending unit and the other receiving unit remains a receiving unit.

12. The communication system of claim 8 further considers a method of authentication wherein shared secret bits and some of the bits of a generated key are used to authenticate the remaining generated bits and the authenticated generated bits, are used in next time authentication.

13. The communication system according to claim 8 further considers perfect transmission of each bit as a message by further encoding, and
imperfect transmission of each signal representing a bit when error is acceptable within the tolerable limit.
